(19) United States
(12) Patent Application Publication
(10) Pub. No.: US 2025/0140933 A1
(43) Pub. Date: May 1, 2025

(54) SOLID-STATE ELECTROCHEMICAL CELL

(71) Applicant: Dyson Technology Limited, Wiltshire (GB)

(72) Inventors: Neil Ross SIM, Swindon (GB); Michael Edward RENDALL, Newbury (GB); Samuel John ALEXANDER, Gloucester (GB)

(21) Appl. No.: 18/694,183

(22) PCT Filed: Sep. 26, 2022
(86) PCT No.: PCT/GB2022/052431

§ 371 Date: Mar. 21, 2024

(30) Foreign Application Priority Data
Sep. 30, 2021 (GB) 2114037.1

(51) Int. Cl. H01M 10/0585; H01M 4/04

(52) U.S. Cl. CPC H01M 10/0585; H01M 4/0471

(57) ABSTRACT

Solid-state electrochemical cells are disclosed. In examples, the cell comprises a cathode current collector, a sintered cathode layer arranged on the cathode current collector, a sintered electrolyte layer arranged on the sintered cathode layer, a sintered anode layer arranged on the sintered electrolyte layer, and an anode current collector arranged on the anode layer. Also described herein are methods of manufacturing said solid-state electrochemical cells, battery stacks comprising a plurality of said solid-state electrochemical cells, and electrically-powered devices comprising the solid-state electrochemical cell or battery stack.

### TECHNICAL FIELD

The present invention relates to solid-state electrochemical cells, methods of manufacturing solid-state electrochemical cells, battery stacks comprising a plurality of solid-state electrochemical cells, and electrically-powered devices comprising solid-state electrochemical cells.

### BACKGROUND

Manufacturing solid-state secondary (rechargeable) cells is a complex and, to date, expensive process. Manufacturing solid-state secondary cells typically involves depositing very thin layers of active materials sequentially on top of each other, then stacking multiples of these elements to provide a battery stack. However, due to the size and form factors of these elements, this stacking process is difficult and time-consuming, with many opportunities for error.

Moreover, the precursor materials for solid-state electrochemical cells are often reactive in nature, leading to a requirement for vacuum, inert, or tightly humidity-controlled atmospheres during manufacture of the solid-state electrochemical cell.

### SUMMARY

In examples of a first aspect of the present disclosure there is provided a solid-state electrochemical cell comprising a cathode current collector, a sintered cathode layer arranged on the cathode current collector, a sintered electrolyte layer arranged on the sintered cathode layer, a sintered anode layer arranged on the sintered electrolyte layer, and an anode current collector arranged on the anode layer.

The inventors have identified that a solid-state electrochemical cell as described hereinabove can have improved interfacial contact, providing improved conductivity through the solid-state electrochemical cell.

Further, the inventors have identified that solid-state electrochemical cells according to these examples comprising a cathode and/or anode of greater thickness can have comparable conductivity to unsintered cathodes and anodes of lesser thickness.

Cathodes and/or anodes of greater thickness provide an increased capacity to the solid-state electrochemical cell. Therefore, fewer solid-state electrochemical cells are required to provide a battery stack of a suitable capacity, thereby simplifying methods of manufacturing battery stacks.

The sintered cathode layer comprises cathode material. In examples, the cathode material comprises, consists essentially of, or consists of: lithium nickel manganese oxide (LiNi_{0.5}Mn_{1.5}O₄), typically referred to as LNMO; lithium cobalt oxide (LiCoO₂), typically referred to as LCO; lithium manganese oxide (LiMn₂O₄), typically referred to as LMO; lithium titanate (Li₄Ti₅O₁₂), typically referred to as LTO); lithium nickel manganese cobalt oxide (LiNi_{1-x-y}MnₓCo_{y}O₂), typically referred to as NMC; lithium iron phosphate (LiFePO₄), typically referred to as LFP, lithium nickel cobalt aluminium oxide (LiNi_{1-x-y}CoₓAl_{y}O₂), typically referred to as NCA; lithium sulfide (Li₂S); silver vanadium oxide (AgV₂O_{5.5}), typically referred to as SVO; or combinations thereof. In particular examples, the cathode material comprises, consists essentially of, or consists of LNMO.

In examples, the cathode layer further comprises binders, conductive additives, sintering agents, or combinations thereof.

The sintered electrolyte layer comprises electrolyte material, typically ceramic material. In examples, the electrolyte material comprises, consists essentially of, or consists of: perovskite-type Li-ion conductor; anti-perovskite-type Li-ion conductor; garnet-type Li-ion conductor; sodium super ionic Li-ion conductor (NASICON); NASICON-related Li-ion conductor; lithium super ionic conductor (LISICON); LISICON-related Li-ion conductor; thio-LISICON; thio-LISICON-related Li-ion conductor; lithium phosphorous oxy-nitride (LiPON); lithium aluminium titanium phosphate (Li_{1.3}Al_{0.3}Ti_{1.7} (PO₄)₃, typically referred to as LATP), related amorphous glassy type Li-ion conductors, or combinations thereof. In particular examples, the electrolyte material comprises, consists essentially of, or consists of LATP.

In examples, the sintered electrolyte layer further comprises binders, conductive additives, sintering agents, or combinations thereof.

The sintered anode layer comprises anode material. In examples, the anode material comprises, consists essentially of, or consists of: silicon, carbon, indium tin oxide (ITO), molybdenum dioxide (MoO₂), lithium titanate (Li₄Ti₅O₁₂-typically referred to as LTO), lithium alloy, metallic lithium, or combinations thereof. Where the anode comprises carbon, the anode comprises any suitable carbon-based material. For example, the anode comprises graphite, graphene, hard carbon, activated carbon, and/or carbon black. In particular examples, the anode material comprises, consists essentially of, or consists of LTO.

In examples, the sintered anode layer further comprises binders, conductive additives, sintering agents, or combinations thereof.

The electrodes of the solid-state electrochemical cells are provided as layers. A layer extends in a first dimension (thickness), second dimension (length), and third dimension (width). Typically, the thickness of a layer is its smallest dimension and the length of the layer is its greatest dimension, although this is not necessarily the case. In examples of the first aspect, the first dimension of the layers (e.g. the thicknesses) extend in the direction that the sintered layers are stacked in the solid-state electrochemical cell. “Thickness” may refer to the overall thickness of a layer, or the thickness (e.g. extent in a first dimension) of a portion of a layer.

In examples, the sintered cathode layer comprises electrolyte material. For example, electrolyte material is dispersed along a thickness of the sintered cathode layer. A portion of sintered cathode layer comprises electrolyte material dispersed along a thickness of that portion. Typically, the electrolyte material is also dispersed along the width and length of the portion of sintered cathode layer.

Advantageously, the inventors have identified that a cathode layer at least partly comprising electrolyte material improves conductivity through the solid-state electrochemical cell. Accordingly, a cathode layer comprising electrolyte material can be provided with a greater thickness while avoiding a reduction in conductivity deriving from the increased thickness.

In examples, a concentration of the electrolyte material along the thickness of the sintered cathode layer decreases towards the sintered electrolyte layer. In the portion comprising electrolyte material, the concentration of electrolyte material decreases along the thickness of the portion towards the sintered electrolyte layer. In some of these examples, the sintered cathode layer comprises a portion abutting the sintered electrolyte layer, the portion substantially free of electrolyte material. Therefore, the sintered cathode layer comprises a portion comprising electrolyte material, and a portion substantially free of electrolyte material. The portion comprising electrolyte material abuts the cathode current collector, in examples. The portion substantially free of electrolyte material is closer to the sintered electrolyte material than the portion comprising electrolyte material. The portion comprising electrolyte material and the portion substantially free of electrolyte material each have a thickness (e.g. extent in the first dimension) less than the thickness of the sintered cathode layer. The portions are of the same thickness, or of different thicknesses. In examples, the thickness of the portion comprising electrolyte material is greater than the thickness of the portion substantially free of electrolyte material.

In other examples, the concentration of the electrolyte material along the thickness of the sintered cathode layer increases towards the sintered electrolyte layer. In the portion comprising electrolyte material, the concentration of electrolyte material increases towards the sintered electrolyte layer. In some of these examples, the sintered cathode layer comprises a portion abutting the cathode current collector, the portion substantially free of electrolyte material. Therefore, the sintered cathode layer comprises a portion comprising electrolyte material, and a portion substantially free of electrolyte material. The portion substantially free of electrolyte material is closer to the cathode current collector than the portion comprising electrolyte material. The portion comprising electrolyte material abuts the sintered electrolyte layer, in examples. The portion comprising electrolyte material and the portion substantially free of electrolyte material each have a thickness (e.g. extent in the first dimension) less than the thickness of the sintered cathode layer. The portions are of the same thickness, or of different thicknesses. In examples, the thickness of the portion comprising electrolyte material is greater than the thickness of the portion substantially free of electrolyte material.

In examples, the sintered cathode layer comprises approximately 1% to 30% electrolyte material by dry weight of the sintered cathode layer, or 10 to 20%.

In examples, the sintered anode layer comprises electrolyte material. For example, electrolyte material is dispersed along a thickness of the sintered anode layer. A portion of sintered anode layer comprises electrolyte material dispersed along a thickness of that portion. Typically, the electrolyte material is also dispersed along the width and length of the portion of sintered anode layer.

As with the sintered cathode layer, the inventors have identified that a sintered anode layer at least partly comprising electrolyte material improves conductivity through the solid-state electrochemical cell. Accordingly, an anode layer comprising electrolyte material can be provided with a greater thickness while avoiding a reduction in conductivity deriving from the increased thickness.

In examples, a concentration of the electrolyte material along the thickness of the sintered anode layer decreases towards the sintered electrolyte layer. In the portion comprising electrolyte material, the concentration of electrolyte material decreases along the thickness of the portion towards the sintered electrolyte layer. In some of these examples, the sintered anode layer comprises a portion abutting the sintered electrolyte layer, the portion substantially free of electrolyte material. Therefore, the sintered anode layer comprises a portion comprising electrolyte material, and a portion substantially free of electrolyte material. The portion comprising electrolyte material abuts the anode current collector, in examples. The portion substantially free of electrolyte material is closer to the sintered electrolyte material than the portion comprising electrolyte material. The portion comprising electrolyte material and the portion substantially free of electrolyte material each have a thickness (e.g. extent in the first dimension) less than the thickness of the sintered anode layer. The portions are of the same thickness, or of different thicknesses. In examples, the thickness of the portion comprising electrolyte material is greater than the thickness of the portion substantially free of electrolyte material.

In other examples, the concentration of the electrolyte material along the thickness of the sintered anode layer increases towards the sintered electrolyte layer. In the portion comprising electrolyte material, the concentration of electrolyte material increases towards the sintered electrolyte layer. In some of these examples, the sintered anode layer comprises a portion abutting the anode current collector, the portion substantially free of electrolyte material. Therefore, the sintered anode layer comprises a portion comprising electrolyte material, and a portion substantially free of electrolyte material. The portion substantially free of electrolyte material is closer to the anode current collector than the portion comprising electrolyte material. The portion comprising electrolyte material abuts the sintered electrolyte layer, in examples. The portion comprising electrolyte material and the portion substantially free of electrolyte material each have a thickness (e.g. extent in the first dimension) less than the thickness of the sintered anode layer. The portions are of the same thickness, or of different thicknesses. In examples, the thickness of the portion comprising electrolyte material is greater than the thickness of the portion substantially free of electrolyte material.

In examples, the sintered anode layer comprises approximately 1% to 30% electrolyte material by dry weight of the sintered anode layer, or 10 to 20%.

In particular examples, both the sintered cathode layer and the sintered anode layer comprise electrolyte material. The sintered cathode layer and the sintered anode layer comprises a portion comprising electrolyte material, wherein the electrolyte material is dispersed throughout the length, width, and thickness of the portion.

In examples, the concentration of the electrolyte material in the sintered cathode layer and the sintered anode layer increases towards the sintered electrolyte layer. For example, the sintered cathode layer and the sintered anode layer each comprise sub-layers, wherein the concentration of electrolyte in each sublayer is greater than its adjacent sublayer which is further from the sintered electrolyte layer, and less than its adjacent sublayer which is closer to the sintered electrolyte layer.

In some examples, the sintered cathode layer comprises a portion substantially free of electrolyte material, the portion abutting the cathode current collector, and/or the sintered anode layer comprises a portion substantially free of electrolyte material, the portion abutting the anode current collector. The portions of sintered cathode layer and sintered anode layer comprising electrolyte material abut the sintered electrolyte layer, in examples.

In other examples, the concentration of the electrolyte material in the sintered cathode layer and the sintered anode layer decreases towards the sintered electrolyte layer. For example, the sintered cathode layer and the sintered anode layer each comprise sub-layers, wherein the concentration of electrolyte in each sublayer is less than its adjacent sublayer which is further from the sintered electrolyte layer, and greater than its adjacent sublayer which is closer to the sintered electrolyte layer.

In some examples, the sintered cathode layer comprises a portion substantially free of electrolyte material, the portion abutting the sintered electrolyte layer, and/or the sintered anode layer comprises a portion substantially free of electrolyte material, the portion abutting the sintered electrolyte layer. The portions of sintered cathode layer and sintered anode layer comprising electrolyte material abut the cathode current collector and anode current collector respectively, in examples.

In examples, the sintered electrolyte layer is substantially free of cathode material and/or anode material.

In examples of a second aspect of the present disclosure, there is provided a method of manufacturing a solid-state electrochemical cell. The method comprises providing a precursor laminate, the precursor laminate comprising: a cathode precursor layer comprising cathode precursor; an electrolyte precursor layer comprising electrolyte precursor; and an anode precursor layer comprising anode precursor. The method further comprises sintering the precursor laminate to provide a sintered laminate comprising a cathode layer, an electrolyte layer, and an anode layer.

The inventors have identified that solid-state electrochemical cells comprising a plurality of sintered layers which have been sintered separately and then combined typically suffer from reduced performance (e.g. reduced capacity and/or reduced conductivity). Without wishing to be bound by theory, the inventors believe that this (at least in part) is due to poor interfacial contact between the layers, deriving from the surface roughness separately-sintered layers.

However, by providing a plurality of precursor layers together and then sintering them together according to the second aspect the interfacial contact between the layers is improved, thereby providing improved performance (e.g. improved capacity and/or improved conductivity).

The sintering typically comprises heating the precursor material and/or subjecting the precursor material to increased pressure (e.g. a pressure greater than 1 atm) such that the precursor coalesces into a solid (e.g. monolithic) layer without undergoing liquefaction. Suitable sintering techniques are known to the skilled person. In examples, the sintering comprises heating the precursor laminate to a temperature less than the lowest melting point of the precursor materials comprised in the precursor laminate.

According to this aspect, the cathode precursor layer, electrolyte precursor layer, and anode precursor layer are sintered simultaneously (e.g. co-sintered) to provide the sintered laminate.

A cathode precursor is material which, through undergoing chemical or physical treatment, provides cathode material. For example, cathode precursor subjected to a sintering process provides cathode material.

Similarly, an electrolyte precursor is material which, through undergoing chemical or physical treatment, provides electrolyte material. For example, electrolyte precursor subjected to a sintering process provides cathode material. Further, an anode precursor is material which, through undergoing chemical or physical treatment, provides anode material. For example, anode precursor subjected to a sintering process provides anode material.

In examples, the chemical composition of the precursor corresponds to and/or is the same as the material provided by chemical or physical treatment of the precursor.

In examples, the cathode precursor comprises, consists essentially of, or consists of: lithium nickel manganese oxide (LiNi_{0.5}Mn_{1.5}O₄), typically referred to as LNMO; lithium cobalt oxide (LiCoO₂), typically referred to as LCO; lithium manganese oxide (LiMn₂O₄), typically referred to as LMO; lithium titanate (Li₄Ti₅O₁₂), typically referred to as LTO); lithium nickel manganese cobalt oxide (LiNi_{1-x-y}MnₓCo_{y}O₂), typically referred to as NMC; lithium iron phosphate (LiFePO₄), typically referred to as LFP, lithium nickel cobalt aluminium oxide (LiNi_{1-x-y}CoₓAl_{y}O₂), typically referred to as NCA;, lithium sulfide (Li₂S); silver vanadium oxide (AgV₂O_{5.5}), typically referred to as SVO; or combinations thereof. In particular examples, the cathode precursor comprises, consists essentially of, or consists of LNMO.

In examples, the electrolyte precursor comprises, consists essentially of, or consists of: sodium super ionic Li-ion conductor (NASICON); NASICON-related Li-ion conductor; lithium super ionic conductor (LISICON); LISICON-related Li-ion conductor; thio-LISICON; thio-LISICON-related Li-ion conductor; lithium phosphorous oxy-nitride (LiPON); lithium aluminium titanium phosphate (Li_{1.3}Al_{0.3}Ti_{1.7} (PO₄)₃, typically referred to as LATP), or combinations thereof. In particular examples, the electrolyte precursor comprises, consists essentially of, or consists of LATP.

In examples, the anode precursor comprises, consists essentially of, or consists of: indium tin oxide (ITO), molybdenum dioxide (MoO₂), lithium titanate (Li₄Ti₅O₁₂-typically referred to as LTO), lithium alloy, metallic lithium, or combinations thereof. In particular examples, the anode precursor comprises, consists essentially of, or consists of LTO.

In particular examples, the cathode precursor comprises, consists essentially of, or consists of LNMO; the electrolyte precursor comprises, consists essentially of, or consists of LATP; and the anode precursor comprises, consists essentially of, or consists of LTO.

Simultaneous sintering of a plurality of precursor layers can be challenging due to disparity in melting temperatures between components of the precursor layers. However, the inventors have identified that LNMO, LATP, and LTO in particular are compatible for use in a simultaneous sintering process such that acceptable sintering of layers of cathode precursor, electrolyte precursor, and anode precursor in a precursor laminate can be achieved under the same sintering conditions.

In examples, the cathode precursor layer, electrolyte precursor layer, and/or the anode precursor layer further comprises binders, conductive additives, sintering agents, or combinations thereof.

The precursors are provided in any suitable form. For example, one or more of the precursors is provided as a powder. The precursor layer therefore comprises a layer of precursor powder which undergoes a sintering process to provide a monolithic sintered layer comprising active material.

In examples, the providing the precursor laminate comprises providing a cathode precursor layer (e.g. depositing cathode precursor onto a substrate), providing an electrolyte precursor layer on the cathode precursor layer to provide an electrolyte precursor layer (e.g. depositing electrolyte precursor on the cathode precursor layer to provide an electrolyte precursor layer abutting the cathode precursor layer), and providing an anode precursor layer on the electrolyte precursor layer (e.g. depositing anode precursor on the electrolyte precursor layer to provide an anode precursor layer abutting the electrolyte precursor layer), thereby providing the precursor laminate. The precursor laminate therefore comprises an anode precursor layer, an electrolyte precursor layer, a cathode precursor layer, and a cathode current collector precursor layer.

The providing the cathode precursor layer, electrolyte precursor layer, and anode precursor layer comprises any suitable deposition method.

In examples, the depositing comprises physical vapour depositing. Physical vapour deposition (PVD) is an example of vacuum deposition and refers to a process wherein a condensed material is vaporised, and then at least some of the vaporised material condenses on a substrate to provide a condensed layer. Examples of PVD include thermal deposition (also referred to as evaporative deposition), and sputtering.

In examples, the depositing comprises chemical vapour depositing. Chemical vapour deposition (CVD) is an example of vacuum deposition and refers to a process wherein a substrate is exposed to one or more volatile precursors, which react and/or decompose on the substrate surface to produce a layer. Examples of CVD include low pressure chemical vapour deposition (LPCVD) and plasma enhanced chemical vapour deposition (PECVD).

In examples, the depositing comprises electrophoretic depositing. Electrophoretic deposition refers to a process wherein colloidal particles suspended in a liquid medium migrate under the influence of an electric field (electrophoresis) and are deposited onto a substrate. Examples of electrophoretic deposition include electrocoating, electrodeposition, and electrophoretic coating, and electrophoretic painting.

In examples, the depositing comprises casting. Examples of casting include spray casting, sheet casting, and spin casting. In examples, the depositing comprises screen printing.

In examples, the precursor laminate further comprises cathode current collector precursor and/or an anode current collector precursor. In these examples, the providing the precursor laminate comprises providing cathode current collector precursor to the cathode precursor layer to provide a cathode current collector precursor layer opposed to the electrolyte precursor layer, and/or providing anode current collector precursor to the anode precursor layer to provide an anode current collector precursor layer opposed to the electrolyte precursor layer. The precursor laminate therefore comprises an anode current collector precursor layer, an anode precursor layer, an electrolyte precursor layer, and a cathode precursor layer. The anode current collector precursor layer and/or the anode precursor layer are provided according to any suitable method, such as those described hereinabove in relation to the providing the cathode, anode, and electrolyte precursor layers.

In examples, the precursor laminate comprises an anode current collector precursor layer, an anode precursor layer, an electrolyte precursor layer, a cathode precursor layer, and a cathode current collector precursor layer.

In examples, the anode current collector precursor and/or the cathode current collector precursor comprises, consists essentially of, or consists of titanium nitride (TiN).

In examples, the method comprises providing a cathode current collector and/or an anode current collector to the sintered laminate, such as an unsintered portion of cathode current collector and/or an unsintered portion of anode current collector. In examples, the unsintered portion of cathode current collector and/or the unsintered portion of anode current collector comprises a metal foil (e.g. copper, tungsten, nickel, platinum, or stainless steel).

In examples, the cathode current collector and/or anode current collector comprises a sintered portion and an unsintered portion. For example, the method comprises providing a precursor laminate comprising an anode current collector precursor layer, an anode precursor layer, an electrolyte precursor layer, a cathode precursor layer, and a cathode current collector precursor layer, sintering the precursor laminate to provide a laminate comprising a sintered anode current collector layer, a sintered anode layer, a sintered electrolyte layer, a sintered cathode layer, and a sintered cathode current collector layer, providing an unsintered portion of anode current collector to the sintered anode current collector layer, thereby providing an anode current collector comprising a sintered portion and an unsintered portion, and providing an unsintered portion of cathode current collector to the sintered cathode current collector layer, thereby providing a cathode current collector comprising a sintered portion and an unsintered portion.

In examples, the cathode precursor layer and/or the anode precursor layer comprises electrolyte precursor. The inventors have identified that providing electrolyte precursor in the cathode precursor layer and/or the anode precursor layer addresses the problem of each layer having its own sintering temperature (e.g. the temperature at which the material is sintered).

Typically, the electrolyte precursor requires a higher temperature for sintering than the anode and/or cathode precursor. Providing electrolyte material in the anode and/or cathode precursor layer means that the precursor laminate can be heated to a higher temperature without substantial melting of the anode and/or cathode precursor. Without wishing to be bound be theory, the inventors believe that the electrolyte material dispersed throughout the anode and/or cathode precursor layer absorbs thermal energy from the surrounding anode and/or cathode precursor such that the anode/and or cathode precursor can be heated to temperatures greater than their usual melting points without substantial melting occurring.

In examples, the cathode precursor layer comprises electrolyte precursor. For example, the providing the cathode precursor layer comprises providing a mixture of cathode precursor and electrolyte precursor to provide at least a portion of a cathode precursor layer which comprises cathode precursor and electrolyte precursor.

In examples, the electrolyte precursor is dispersed along a thickness of the cathode precursor layer. For example, the mixture of cathode precursor and electrolyte precursor is provided for a duration such that a thickness comprising cathode precursor and electrolyte precursor is provided.

In examples, the cathode precursor layer is provided first, then the electrolyte precursor layer, then the anode precursor layer.

In examples, a concentration of electrolyte material along the thickness of the cathode precursor layer decreases towards the electrolyte precursor layer. In these examples, the concentration of electrolyte precursor in the mixture of cathode precursor and electrolyte precursor being provided to the substrate decreases over time, thereby providing a layer in which the concentration of electrolyte precursor decreases from the bottom of the layer to the top. In examples, the method further comprises providing cathode precursor substantially free of electrolyte precursor on top of the mixture of cathode precursor and electrolyte precursor.

In other examples, a concentration of electrolyte material along the thickness of the cathode precursor layer increases towards the electrolyte precursor layer. In these examples, the concentration of electrolyte precursor in the mixture of cathode precursor and electrolyte precursor being provided to the substrate increases over time, thereby providing a layer in which the concentration of electrolyte precursor increases from the bottom of the layer to the top. In examples, the method comprises providing cathode precursor substantially free of electrolyte precursor to the substrate, before the mixture of cathode precursor and electrolyte precursor is provided on top of the layer substantially free of electrolyte precursor.

In examples, the anode precursor layer comprises electrolyte precursor. For example, the providing the anode precursor layer comprises providing a mixture of anode precursor and electrolyte precursor to provide at least a portion of an anode precursor layer which comprises anode precursor and electrolyte precursor.

In examples, the electrolyte precursor is dispersed along a thickness of the anode precursor layer. For example, the mixture of anode precursor and electrolyte precursor is provided for a duration such that a thickness comprising anode precursor and electrolyte precursor is provided.

In examples, a concentration of electrolyte material along the thickness of the anode precursor layer decreases towards the electrolyte precursor layer. In these examples, the concentration of electrolyte precursor in the mixture of anode precursor and electrolyte precursor being provided to the substrate increases over time (if the mixture is being provided to an already-deposited layer of electrolyte precursor), thereby providing a layer in which the concentration of electrolyte precursor decreases from the bottom of the layer to the top. In examples, the method further comprises providing anode precursor substantially free of electrolyte precursor on top of the mixture of anode precursor and electrolyte precursor.

In other examples, a concentration of electrolyte material along the thickness of the anode precursor layer increases towards the electrolyte precursor layer. In these examples, the concentration of electrolyte precursor in the mixture of anode precursor and electrolyte precursor being provided to the substrate decreases over time (if the mixture is being provided to an already-deposited layer of electrolyte precursor), thereby providing a layer in which the concentration of electrolyte precursor increases from the bottom of the layer to the top. In examples, the method comprises providing anode precursor substantially free of electrolyte on top of the layer substantially free of electrolyte precursor.

In examples, the method further comprises separating a first portion of the sintered laminate from a second portion of the sintered laminate along a plane substantially orthogonal to the layers of the sintered laminate to provide a plurality of solid-state electrochemical cells.

In examples of a third aspect of the present disclosure there is provided a solid-state electrochemical cell obtainable from the method according to the second aspect.

In examples of a fourth aspect of the present disclosure there is provided a sintered laminate material comprising a cathode layer, an electrolyte layer, and an anode layer. In examples, the sintered laminate material is obtainable from the method according to the second aspect. In examples, the sintered laminate material the cathode layer, electrolyte layer, and anode layer correspond to the cathode layer, electrolyte layer, and anode layer of the solid-state electrochemical cell according to the first aspect. Accordingly, features described in relation to the first aspect are explicitly disclosed in relation to the fourth aspect, to the extent that they are applicable.

In examples of a further aspect of the present disclosure there is provided a battery stack comprising a plurality of solid-state electrochemical cells according to the first or third aspect.

The plurality of cells may suitably comprise 2, 3, 4, 5, or more than 5 electrochemical cells. Said battery stack typically comprises a plurality of electrochemical cells as described herein.

In examples, the battery stack is a “back-to-back” stack. For example, the cathodes of two cells are arranged to contact a single current collector. Accordingly, in examples wherein the plurality of electrochemical cells comprises a first solid-state electrochemical cell and a second solid-state electrochemical cell, the cathode current collector of the first cell is also the cathode current collector of the second cell.

In examples of a yet further aspect of the present disclosure there is provided an electrically-powered device comprising the solid-state electrochemical cell described herein, or the battery stack described herein. An electrically-powered device is any apparatus which draws electric power from a circuit which includes the cell or battery stack, converting the electric power from the cell or battery stack to other forms of energy such as mechanical work, heat, light, and so on. In examples, the electrically-powered device is a smartphone, a cell phone, a personal digital assistant, a radio player, a music player, a video camera, a tablet computer, a laptop computer, military communications, military lighting, military imaging, a satellite, an aeroplane, a micro air vehicle, a hybrid electric vehicle, a plug-in hybrid electric vehicle, a fully electric vehicle, an electric scooter, an underwater vehicle, a boat, a ship, an electric garden tractor, an unmanned aero drone, an unmanned aeroplane, an RC car, a robotic toy, a vacuum cleaner such as a robotic vacuum cleaner, a robotic garden tool, a robotic construction utility, a robotic alert system, a robotic aging care unit, a robotic kid care unit, an electric drill, an electric mower, an electric vacuum cleaner, an electric metal working grinder, an electric heat gun, an electric press expansion tool, an electric saw or cutter, an electric sander and polisher, an electric shear and nibbler, an electric router, an electric tooth brush, an electric hair dryer, an electric hand dryer, a global positioning system (GPS) device, a laser rangefinder, a torch (flashlight), an electric street lighting, a standby power supply, uninterrupted power supplies, or another portable or stationary electronic device.

Features described herein in relation to one aspect of the present disclosure are explicitly disclosed in combination with the other aspects, to the extent that they are compatible.

Further features and advantages of the invention will become apparent from the following description of preferred embodiments of the invention, given by way of example only, which is made with reference to the accompanying drawings.

### BRIEF DESCRIPTION OF THE DRAWINGS

FIGS. 1, 2, 3, and 4 are schematic diagrams of cross-sections of solid-state electrochemical cells according to examples.

FIG. 5 is a flow chart of a method of manufacturing a solid-state electrochemical cell according to examples.

FIGS. 6, 7, 8, and 9 are schematic flow diagrams of methods according to examples, depicting cross-sections of solid-state electrochemical cell precursors and solid-state electrochemical cells at points in the methods.

FIG. 10 is a schematic diagram of a cross-section of a battery stack according to examples.

FIG. 11 is a schematic diagram of an electrically-powered device according to examples.

### DETAILED DESCRIPTION

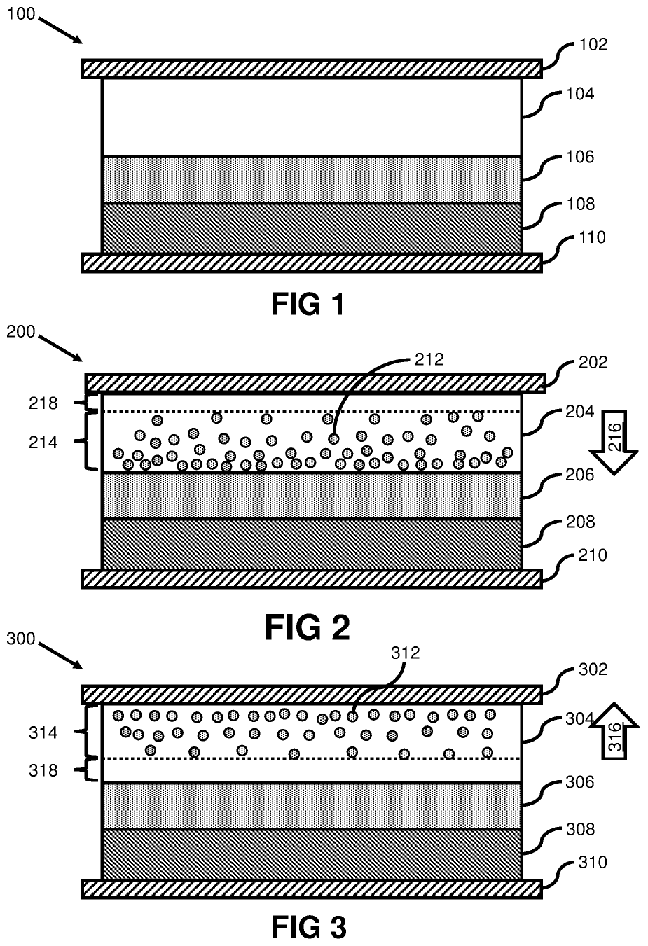

FIG. 1 is a schematic diagram of a cross-section of a solid-state electrochemical cell 100 according to examples. The solid-state electrochemical cell 100 comprises a cathode current collector 102, a sintered cathode layer 104 abutting the cathode current collector 102, a sintered electrolyte layer 106 abutting the sintered cathode layer 104, a sintered anode layer 108 abutting the sintered electrolyte layer 106, and an anode current collector 110 abutting the sintered anode layer 108.

FIG. 2 is a schematic diagram of a cross-section of a solid-state electrochemical cell 200 according to examples. The solid-state electrochemical cell 200 comprises a cathode current collector 202, a sintered cathode layer 204 abutting the cathode current collector 202, a sintered electrolyte layer 206 abutting the sintered cathode layer 204, a sintered anode layer 208 abutting the sintered electrolyte layer 206, and an anode current collector 210 abutting the sintered anode layer 208.

The sintered cathode layer 204 comprises electrolyte material 212 disposed along a thickness 214 of the sintered cathode layer 204. The concentration of the electrolyte material 212 increases along the thickness 214 of the sintered cathode layer 204 from the cathode current collector 202 towards the sintered electrolyte layer 206 (e.g. the concentration of electrolyte material 212 along the thickness 214 of the sintered cathode layer 204 increases in the direction indicated by the arrow 216 in FIG. 2). Put another way, the concentration of the electrolyte material 212 decreases along the thickness 214 of the sintered cathode layer 204 from the sintered electrolyte layer 206 towards the cathode current collector 202.

The sintered cathode layer 204 depicted in FIG. 2 comprises a portion 218 abutting the cathode current collector 202 which is substantially free of electrolyte material 212. The thickness 214 of the sintered cathode layer 204 comprising electrolyte material 212 can be referred to as a cathode-electrolyte layer; the portion 218 abutting the cathode current collector 202 can be referred to as a cathode-only layer. In other examples (not shown), the sintered cathode layer 204 does not comprise a portion 218 abutting the cathode current collector 202 which is substantially free of electrolyte material 212.

FIG. 3 is a schematic diagram of a cross-section of a solid-state electrochemical cell 300 according to examples. The solid-state electrochemical cell 300 comprises a cathode current collector 302, a sintered cathode layer 304 abutting the cathode current collector 302, a sintered electrolyte layer 306 abutting the sintered cathode layer 304, a sintered anode layer 308 abutting the sintered electrolyte layer 306, and an anode current collector 310 abutting the anode layer 308.

The sintered cathode layer 304 comprises electrolyte material 312 disposed along a thickness 314 of the sintered cathode layer 304. The concentration of the electrolyte material 312 decreases along the thickness 314 of the sintered material from the cathode current collector 302 towards the sintered electrolyte layer 306. Put another way, the concentration of the electrolyte material 312 increases along the thickness 314 of the sintered cathode layer 304 from the sintered electrolyte layer 306 towards the cathode current collector 302 (e.g. the concentration of the electrolyte material 312 increases along the thickness 314 of the sintered cathode layer 304 in the direction indication by the arrow 316 in FIG. 3).

The sintered cathode layer 304 comprises a portion 318 abutting the sintered electrolyte layer 306 which is substantially free of electrolyte material 312. The thickness 314 of the sintered cathode layer 304 comprising electrolyte material 312 can be referred to as a cathode-electrolyte layer; the portion 318 abutting the sintered electrolyte layer 306 can be referred to as a cathode-only layer. In other examples (not shown), the sintered cathode layer 304 does not comprise a portion 318 abutting the sintered cathode layer 304 which is substantially free of electrolyte material 312.

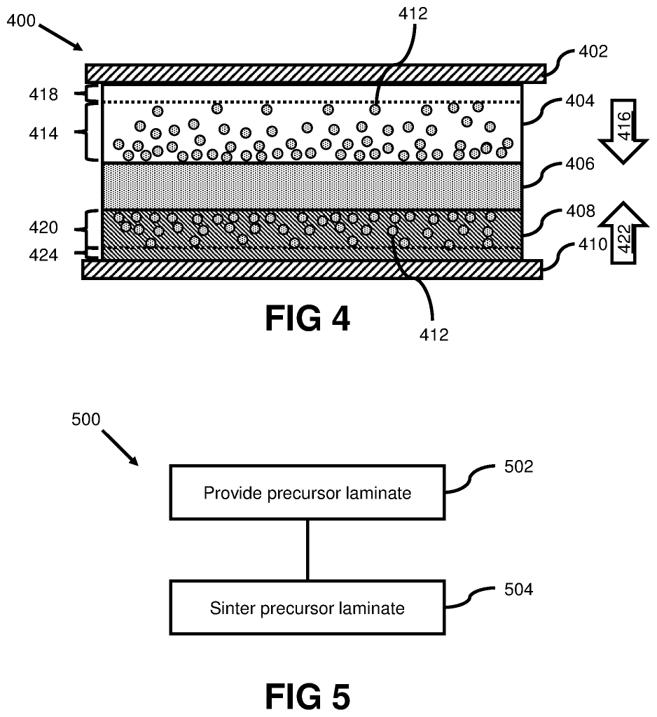

FIG. 4 is a schematic diagram of a cross-section of a solid-state electrochemical cell 400 according to examples. The solid-state electrochemical cell 400 depicted in FIG. 4 corresponds to the solid-state electrochemical cell 200 of FIG. 2 except that the anode layer 408 comprises electrolyte material 312. Features of the solid-state electrochemical cell 400 depicted in FIG. 4 which correspond to those of the solid-state electrochemical cell depicted in FIG. 2 are indicated with the reference numerals of FIG. 2, increased by 200.

The sintered anode layer 408 comprises electrolyte material 412 disposed along a thickness 420 of the sintered anode layer 408. The concentration of the electrolyte material 412 increases along the thickness 420 of the sintered anode layer 404 from the anode current collector 410 towards the sintered electrolyte layer 406 (e.g. the concentration of electrolyte material 412 increases in the direction indicated by the arrow 422 in FIG. 4). Put another way, the concentration of the electrolyte material 412 decreases along the thickness 420 of the sintered anode layer 408 from the sintered electrolyte layer 406 towards the anode current collector 410.

The sintered anode layer 408 comprises a portion 424 which is substantially free of electrolyte material 412. The thickness 420 of the sintered cathode layer 408 comprising electrolyte material 412 can be referred to as an anode-electrolyte layer; the portion 424 abutting the anode current collector 410 can be referred to as an anode-only layer.

In other examples of solid-state electrochemical cells which are not depicted in the Figures, the solid-state electrochemical cell comprises a sintered anode layer which comprises electrolyte material, and a sintered cathode layer which is substantially free of electrolyte material. The electrolyte material comprised in the sintered anode layer is, in examples, dispersed throughout the layer in the same manner as taught in any of the examples referred to hereinabove.

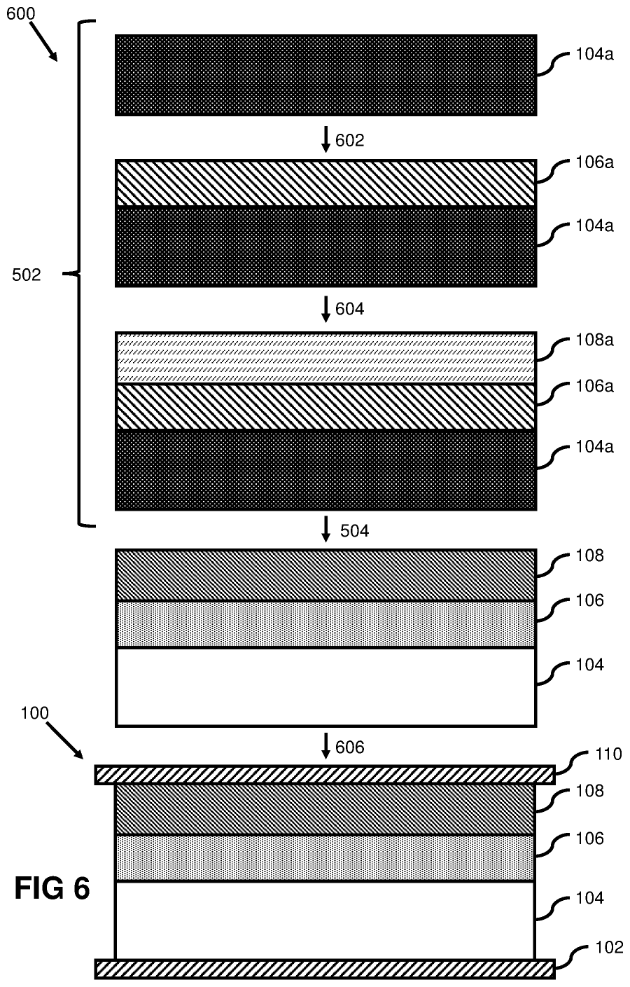

FIG. 5 is a flow chart of a method 500 of manufacturing a solid-state electrochemical cell according to examples. The method 500 comprises providing 502 a precursor laminate. The precursor laminate comprises a cathode precursor layer (comprising cathode precursor), an electrolyte precursor layer (comprising electrolyte precursor) abutting the cathode precursor layer, and an anode precursor layer (comprising anode precursor) abutting the electrolyte precursor layer. Exemplary methods of providing a precursor laminate are discussed below in relation to FIGS. 6 to 9.

The method 500 further comprises sintering 504 the precursor laminate to provide a sintered laminate comprising a cathode layer (sintered cathode layer), an electrolyte layer (sintered electrolyte layer), and an anode layer (sintered anode layer). The sintering is performed according to any of the suitable methods described hereinabove.

In examples (not shown), the method further comprises providing an anode current collector on the anode layer, and providing a cathode current collector on the cathode layer.

FIG. 6 is a schematic flow diagrams of a method 600 of manufacturing a solid-state electrochemical cell according to examples, depicting cross-sections of solid-state electrochemical cell precursors and a solid-state electrochemical cell at points in the method. The method 600 depicted in FIG. 6 corresponds to the method 500 depicted in FIG. 5 for manufacturing the solid-state electrochemical cell 100 depicted in FIG. 1. Where components of the method or the solid-state electrochemical cell depicted in FIG. 6 correspond to those depicted in FIGS. 1 and 5, the same reference numerals are used. Where components in FIG. 6 are precursors to components depicted in FIG. 1, the same reference numerals are used with the letter “a” appended.

The method 600 comprises providing a cathode precursor layer 104a (e.g. comprising depositing cathode precursor onto a substrate), depositing 602 electrolyte precursor on the cathode precursor layer 104a to provide an electrolyte precursor layer 106a, and depositing 604 anode precursor on the electrolyte precursor layer 104a to provide an anode precursor layer 108a. The depositing of the precursor materials to provide the precursor layers 104a, 106a, 108a comprises a screen-printing process. In other examples (not shown), the depositing of the precursor materials comprises any of the deposition techniques described hereinabove.

The cathode precursor layer 104a, the electrolyte precursor layer 106a, and the anode precursor layer 108a taken together is a laminate precursor. Thus, the providing the cathode precursor layer 104a, depositing the 602 electrolyte precursor, and depositing 604 the anode precursor corresponds to the providing 502 a precursor laminate as depicted in FIG. 5.

The laminate precursor comprising the cathode precursor layer 104a, the electrolyte precursor layer 106a, and the anode precursor layer 108a is sintered 504 to provide a sintered laminate comprising a cathode layer 104, an electrolyte layer 106, and an anode layer 108.

The method 600 further comprises providing 606 a cathode current collector 102 on the cathode layer 104 and an anode current collector 110 on the anode layer 108, thereby providing the solid-state electrochemical cell 100 depicted in FIG. 1.

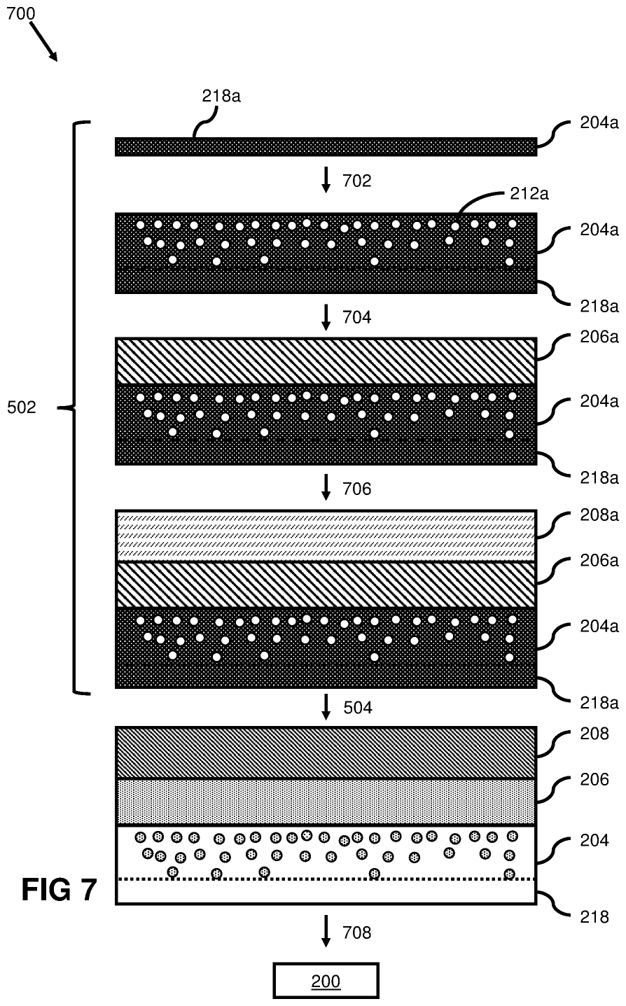

FIG. 7 is a schematic flow diagram of a method 700 of manufacturing a solid-state electrochemical cell according to examples, depicting cross-sections of solid-state electrochemical cell precursors and a solid-state electrochemical cell at points in the method. The method 700 depicted in FIG. 7 corresponds to the method 500 depicted in FIG. 5 for manufacturing the solid-state electrochemical cell 200 depicted in FIG. 2. Where components of the method or the solid-state electrochemical cell depicted in FIG. 7 correspond to those depicted in FIGS. 2 and 5, the same reference numerals are used. Where components in FIG. 7 are precursors to components depicted in FIG. 2, the same reference numerals are used with the letter “a” appended.

The method 700 comprises providing a cathode precursor layer 204a (e.g. comprising depositing cathode precursor onto a substrate). At this stage of the method, the cathode precursor layer 204a is substantially free of electrolyte material, and thus is a precursor 218a to the portion 218 of sintered cathode layer 204 substantially free of electrolyte material 212 of the solid-state electrochemical cell 200 depicted in FIG. 2.

The method 700 further comprises depositing 702 cathode precursor and electrolyte precursor 212a on the portion 218a of cathode precursor layer 204a which is substantially free of electrolyte material to provide a cathode-electrolyte precursor layer. The cathode-electrolyte precursor layer comprises cathode precursor and electrolyte precursor 212a, and overall is a precursor to the thickness 214 of the cathode layer 204 which comprises electrolyte material 212 of the solid-state electrochemical cell 200 of FIG. 2. The depositing 702 comprises providing a mixture of cathode precursor and electrolyte precursor to the portion 218a. In this example, the concentration of electrolyte precursor in the mixture of cathode precursor and electrolyte precursor is gradually increased during depositing, such that the concentration of electrolyte precursor along the thickness of the layer increases as the layer is built up (e.g. the concentration of electrolyte precursor increases in a direction away from the portion 218a substantially free of electrolyte precursor 212a). The portion 218a substantially free of electrolyte precursor 212a and the cathode-electrolyte precursor layer taken together is a precursor 204a to the cathode layer 204 of the solid-state electrochemical cell 200 depicted in FIG. 2. The gradual increasing of electrolyte precursor concentration during deposition of the mixture of cathode precursor and electrolyte precursor can also be described as providing a series of cathode-electrolyte sublayers. The concentration of electrolyte precursor in each sublayer that is provided is greater than the concentration of electrolyte precursor in the earlier-deposited sublayer on which the sublayer is deposited.

The method 700 further comprises depositing 704 electrolyte material (substantially free of cathode precursor) on the cathode precursor layer 204a to provide an electrolyte precursor layer 206a, and depositing 706 anode precursor on the electrolyte precursor layer 204a to provide an anode precursor layer 208a. The depositing of the precursor materials to provide the precursor layers 204a, 206a, 208a comprises a screen-printing process.

The cathode precursor layer 204a (comprising the portion 218a substantially free of electrolyte precursor 212a, and the cathode-electrolyte precursor layer), the electrolyte precursor layer 206a, and the anode precursor layer 208a taken together is a laminate precursor. Thus, the providing the layer 218a of cathode precursor substantially free of electrolyte precursor 212a, the depositing 702 the mixture of cathode precursor and electrolyte precursor, the depositing 704 the electrolyte precursor (substantially free of cathode precursor), and the depositing 706 the anode precursor corresponds to the providing 502 a precursor laminate as depicted in FIG. 5.

The laminate precursor comprising the cathode precursor layer 204a, the electrolyte precursor layer 206a, and the anode precursor layer 208a is sintered 504 to provide a sintered laminate comprising a cathode layer 204 (the cathode layer 204 comprising a portion comprising electrolyte material 212, and a portion substantially free of electrolyte material 218), an electrolyte layer 206, and an anode layer 208.

The method 700 further comprises providing 708 a cathode current collector 202 on the cathode layer 204 and an anode current collector 210 on the anode layer 208, thereby providing the solid-state electrochemical cell 200 depicted in FIG. 2.

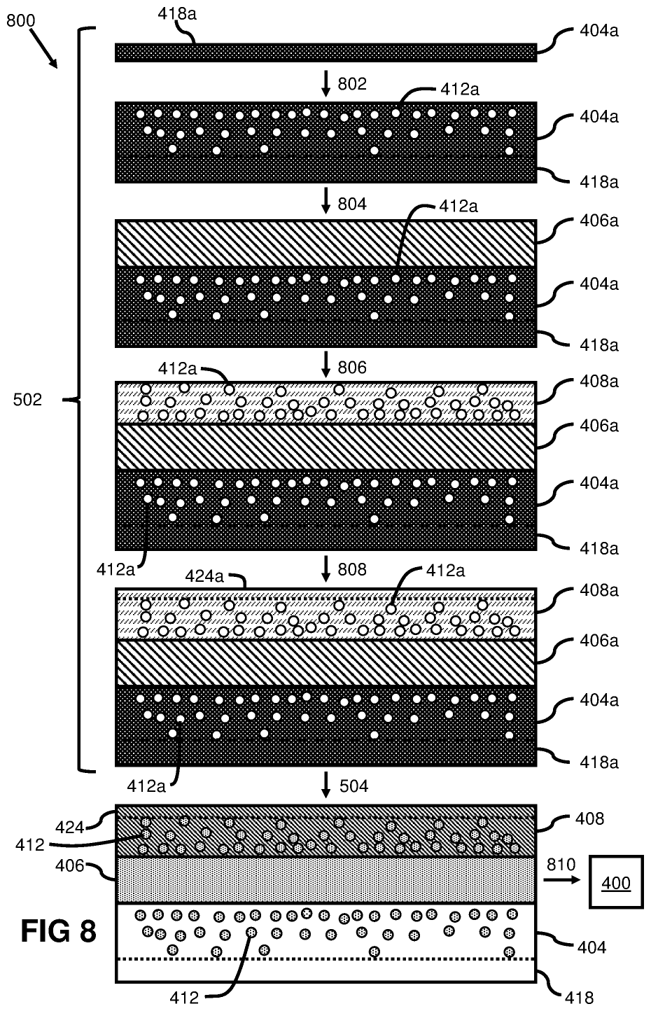

FIG. 8 is a schematic flow diagrams of a method 800 of manufacturing a solid-state electrochemical cell according to examples, depicting cross-sections of solid-state electrochemical cell precursors and a solid-state electrochemical cell at points in the method. The method 800 depicted in FIG. 8 corresponds to the method 500 depicted in FIG. 5 for manufacturing the solid-state electrochemical cell 400 depicted in FIG. 4. Where components of the method or the solid-state electrochemical cell depicted in FIG. 8 correspond to those depicted in FIGS. 4 and 5, the same reference numerals are used. Where components in FIG. 8 are precursors to components depicted in FIG. 4, the same reference numerals are used with the letter “a” appended.

The method 800 comprises providing a portion 418a of cathode precursor layer 404a substantially free of electrolyte precursor 412a, depositing 802 a mixture of cathode precursor and electrolyte precursor on the portion 418a, and depositing 804 electrolyte precursor (substantially free of cathode precursor) on the mixture of cathode precursor and electrolyte precursor in the same way as depicted in FIG. 7.

The method further comprises depositing 806 a mixture of anode precursor and electrolyte precursor on the electrolyte precursor layer 406a to provide an anode-electrolyte precursor layer. The anode-electrolyte precursor layer comprises anode precursor and electrolyte precursor 412a, and overall is a precursor to the thickness 420 of the anode layer 408 which comprises electrolyte material 212 of the solid-state electrochemical cell 400 of FIG. 4. The depositing 806 comprises providing a mixture of anode precursor and electrolyte precursor to the electrolyte precursor layer 406a. In this example, the concentration of electrolyte precursor in the mixture of anode precursor and electrolyte precursor is gradually decreased during depositing, such that the concentration of electrolyte precursor along the thickness of the layer decreases as the layer is built up (e.g. the concentration of electrolyte precursor decreases in a direction away from the electrolyte precursor layer 406a). As before, the gradual decreasing of electrolyte precursor concentration during deposition of the mixture of anode precursor and electrolyte precursor can be described as providing a series of anode-electrolyte sublayers. The concentration of electrolyte precursor in each sublayer that is provided is less than the concentration of electrolyte precursor in the earlier-deposited sublayer on which the sublayer is deposited.

The method further comprising depositing 808 anode precursor substantially free of electrolyte material on the anode-electrolyte precursor layer, thereby providing a precursor 424a to the portion 424 of sintered anode layer 408 substantially free of electrolyte material 412 of the solid-state electrochemical cell 400 of FIG. 4.

The cathode precursor layer 404a (comprising the portion 418a substantially free of electrolyte precursor 412a, and the cathode-electrolyte precursor layer), the electrolyte precursor layer 406a, and the anode precursor layer 408a (comprising the anode-electrolyte precursor layer and the portion 424a substantially free of electrolyte precursor 412a) taken together is a laminate precursor. Thus, the providing the layer 418a of cathode precursor substantially free of electrolyte precursor 412a, the depositing 802 the mixture of cathode precursor and electrolyte precursor, the depositing 804 the electrolyte precursor (substantially free of cathode precursor), the depositing 806 the mixture of anode precursor and electrolyte precursor, and the depositing 808 the anode precursor (substantially free of electrolyte material) corresponds to the providing 502 a precursor laminate as depicted in FIG. 5.

The laminate precursor comprising the cathode precursor layer 404a, the electrolyte precursor layer 406a, and the anode precursor layer 408a is sintered 504 to provide a sintered laminate comprising a cathode layer 404 (the cathode layer 404 comprising a portion 414 comprising electrolyte material 412, and a portion 418 substantially free of electrolyte material 412), an electrolyte layer 406, and an anode layer 408 (the anode layer 408 comprising a portion 420 comprising electrolyte material 412, and a portion 424 substantially free of electrolyte material 412).

The method 800 further comprises providing 810 a cathode current collector 402 on the cathode layer 404 and an anode current collector 410 on the anode layer 408, thereby providing the solid-state electrochemical cell 400 depicted in FIG. 4.

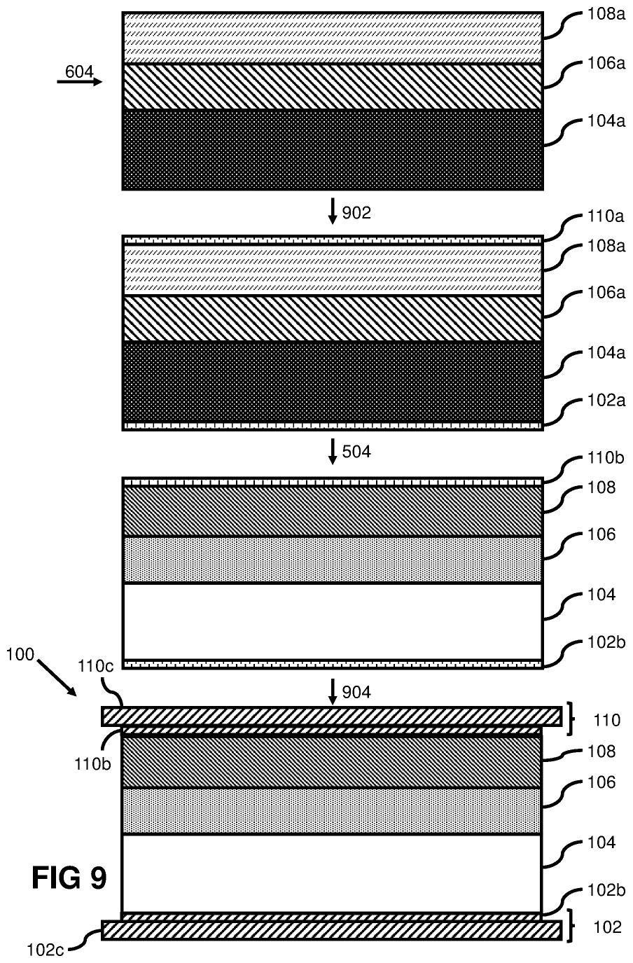

FIG. 9 is a schematic flow diagram of a method 900 of manufacturing a solid-state electrochemical cell according to examples, depicting cross-sections of solid-state electrochemical cell precursors and a solid-state electrochemical cell at points in the method. The method 900 depicted in FIG. 9 is another example of a method of providing the solid-state electrochemical cell 100 depicted in FIG. 1. Where components of the method or the solid-state electrochemical cell depicted in FIG. 9 correspond to those depicted in FIGS. 1 and 5, the same reference numerals are used. Where components in FIG. 6 are precursors to components depicted in FIG. 1, the same reference numerals are used with the letter “a” appended.

A laminate material comprising a cathode precursor layer 104a, an electrolyte precursor layer 106a, and an anode precursor layer 108a is provided by, for example, providing a cathode precursor layer 104a, depositing 602 electrolyte precursor on the cathode precursor layer to provide an electrolyte precursor layer 106a, and depositing 604 anode precursor on the electrolyte precursor layer to provide an anode precursor layer 108a, as depicted in FIG. 6.

The method 900 further comprises depositing 902 cathode current collector precursor on the cathode precursor layer 104a to provide a cathode current collector precursor layer, and depositing anode current collector precursor on the anode precursor layer 108a to provide an anode current collector precursor layer 110a.

In other examples (not shown), the cathode current collector precursor layer 102a is first provided, and then cathode precursor deposited on the cathode current collector precursor layer 102a to provide the cathode precursor layer 104a.

The cathode current collector precursor layer 102a, the cathode precursor layer 104a, the electrolyte precursor layer 106a, the anode precursor layer 108a, and the anode current collector precursor layer taken together is a laminate precursor. Thus, the aforementioned parts of the method corresponds to the providing 502 a precursor laminate as depicted in FIG. 5.

The laminate precursor is sintered 504 to provide a sintered laminate comprising a sintered portion of cathode current collector 102b, a sintered cathode layer 104, a sintered electrolyte layer 106, a sintered anode layer 108, and a sintered portion of anode current collector 110b.

The method 900 further comprises providing 904 an unsintered portion of current collector 102c on the sintered portion of cathode current collector 102b (thereby providing the cathode current collector 102) and providing an unsintered portion of anode current collector 110c on the sintered portion of anode current collector 110b (thereby providing the anode current collector 102). The current collectors 102, 110 each comprise sintered 102b, 110b and unsintered 102c, 110c portions.

In other examples (not shown), the providing 904 the unsintered portions of current collector is omitted, such that the current collectors 102, 110 of the solid-state electrochemical cell 100 comprise only sintered current collector portions 102b, 110b (e.g. the current collectors 102, 110 do not comprise unsintered current collector portions 102c, 110c).

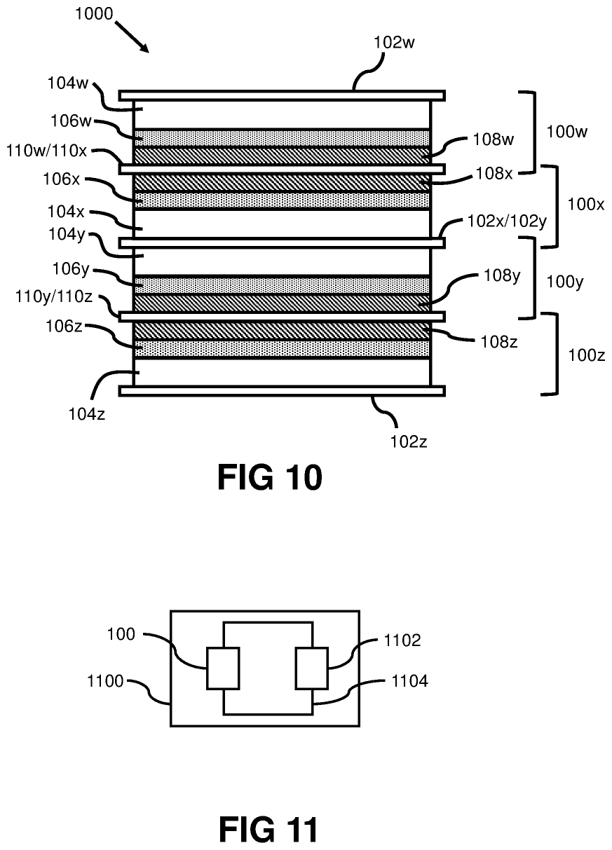

FIG. 10 shows a cross-section of one example of a battery stack 1000 comprising a plurality of electrochemical cells 100w, 100x, 100y, 100z. As shown in FIG. 10, the plurality comprises a first cell 100w, a second cell 100x, a third cell 100y, and a fourth cell 100z. Other examples of battery stack 1000 need only in fact comprise at least two electrochemical cells; the number of cells shown in FIG. 10 is purely exemplary. The description and teaching regarding FIG. 10 is also explicitly disclosed in relation to any battery stack comprising any number of electrochemical cells according to the present disclosure, to the extent that said teaching and said battery stack are technically compatible.

Each cell 100w, 100x, 100y, 100z corresponds to the cell 100 shown in FIG. 1. The components of each cell 100w, 100x, 100y, 100z are labelled using the same numbering used in FIG. 1 to indicate where components are equivalent, appended by “w”, “x”, “y”, or “z” to indicate the cell in which it is comprised.

The battery stack 1000 is a “back-to-back” stack, in which every other cell in the stack is reversed so that each current collector has either an anode on each opposing face or a cathode on each opposing face. In particular, in FIG. 1000, the sintered anode layer 108w of the first cell 100w and the sintered anode layer 108x of the second cell 100x are arranged on opposite faces of an anode current collector 110w/110x. The anode current collector 110w/110x comprises an outer conductive surface and thus is configured to form an electrode on both faces of the layer, e.g. the anode current collector 110w of the first cell 100w and the anode current collector 110x of the second cell 100x. Thus, the anode current collector 110w of the first cell 100w is the anode current collector 110x of the second cell 100x. The same applies to the anode current collector 110y of the third cell 100w and the anode current collector 110z of the fourth cell 100z mutatis mutandis.

The sintered cathode layer 104x of the second cell 100x and the sintered cathode layer 100y of the third cell 100y are arranged on opposite faces of a cathode current collector 102x/102y. The cathode current collector 102x/102y comprises an outer conductive surface and thus is configured to form an electrode on both faces of the layer, e.g. the cathode current collector 102x of the second cell 100x and the cathode current collector 102y of the third cell 100y. Although not shown in FIG. 10, the same applies to the sintered cathode layer 104w and the cathode current collector 102w of the first cell 100w mutatis mutandis, and to the sintered cathode layer 104z and the cathode current collector 102z of the fourth cell 100z mutatis mutandis, if further electrochemical cells are comprised in the battery stack 1000.

FIG. 11 is a schematic diagram of an electrically-powered device according to examples. The electrically-powered device 1100 comprises the solid-state electrochemical cell 100 depicted in FIG. 1. In examples (not shown) the solid-state electrochemical cell is the solid-state electrochemical cell 200 depicted in FIG. 2, the solid-state electrochemical cell 300 depicted in FIG. 3, or the solid-state electrochemical cell 400 depicted in FIG. 4. In examples (not shown), the solid-state electrochemical cell 100, 200, 300, 400 is provided as part of a battery stack, such as the battery stack 1000 depicted in FIG. 10.

The electrically-powered device comprises an element 1102 which converts electric power from the solid-state electrochemical cell 100 to another form of energy (e.g. mechanical work, heat, light, and so on). The solid-state electrochemical cell 100 and element 1102 are connected by one or more electrical conduits 1104 which, in examples, forms an electrical circuit.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A solid-state electrochemical cell comprising:
a cathode current collector;
a sintered cathode layer arranged on the cathode current collector;
a sintered electrolyte layer arranged on the sintered cathode layer;
a sintered anode layer arranged on the sintered electrolyte layer; and
an anode current collector arranged on the anode layer.

2. The solid-state electrochemical cell according to claim 1, wherein the sintered cathode layer comprises electrolyte material.

3. The solid-state electrochemical cell according to claim 2, wherein the electrolyte material is dispersed along a thickness of the sintered cathode layer.

4. The solid-state electrochemical cell according to claim 3, wherein a concentration of the electrolyte material along the thickness of the sintered cathode layer decreases towards the sintered electrolyte layer.

5. The solid-state electrochemical cell according to claim 4, wherein the sintered cathode layer comprises a portion abutting the sintered electrolyte layer, the portion substantially free of electrolyte material.

6. The solid-state electrochemical cell according to claim 3, wherein a concentration of the electrolyte material along the thickness of the sintered cathode layer increases towards the sintered electrolyte layer.

7. The solid-state electrochemical cell according to claim 6, wherein the sintered cathode layer comprises a portion abutting the cathode current collector, the portion substantially free of electrolyte material.

8. The solid-state electrochemical cell according to claim 2, wherein the sintered cathode layer comprises approximately 1% to 30% electrolyte material by dry weight of the sintered cathode layer.

9. The solid-state electrochemical cell according to claim 1, wherein the anode layer comprises electrolyte material.

10. A method of manufacturing a solid-state electrochemical cell comprising:
providing a precursor laminate, the precursor laminate comprising:
a cathode precursor layer comprising cathode precursor;
an electrolyte precursor layer comprising electrolyte precursor; and
an anode precursor layer comprising anode precursor; and
sintering the precursor laminate to provide a sintered laminate comprising a cathode layer, an electrolyte layer, and an anode layer.

11. The method according to claim 10, the precursor laminate further comprising cathode current collector precursor and/or an anode current collector precursor.

12. The method according to claim 11, comprising providing a cathode current collector and/or an anode current collector to the sintered laminate.

13. The method according to claim 12, wherein the cathode current collector and/or anode current collector comprises a sintered portion and an unsintered portion.

14. The method according to claim 10, wherein the cathode precursor layer comprises electrolyte precursor.

15. The method according to claim 14, wherein the electrolyte precursor is dispersed along a thickness of the cathode precursor layer.

16. The method according to claim 15, wherein a concentration of electrolyte material along the thickness of the cathode precursor layer decreases towards the electrolyte precursor layer.

17. The method according to claim 15, wherein a concentration of electrolyte material along the thickness of the cathode precursor layer increases towards the electrolyte precursor layer.

18. The method according to claim 10, comprising separating a first portion of the sintered laminate from a second portion of the sintered laminate along a plane substantially orthogonal to the layers of the sintered laminate to provide a plurality of solid-state electrochemical cells.

19. A solid-state electrochemical cell obtainable from the method according to claim 10.

20. A sintered laminate material comprising a cathode layer, an electrolyte layer on the cathode layer, and an anode layer on the electrolyte layer.

21. A battery stack comprising a plurality of solid-state electrochemical cells according to claim 1.

22. An electrically-powered device comprising the solid-state electrochemical cell according to claim 1.
